(19) United States
(12) Patent Application Publication
(10) Pub. No.: US 2005/0092037 A1
(43) Pub. Date: May 5, 2005

(54) Cable Lock

(75) Inventors: Glenn Meekma, Menomonee Falls, WI (US); John Zapushek, Racine, WI (US); Monica Toomey, Greenfield, WI (US)

Correspondence Address: CALFEE HALTER & GRISWOLD, LLP, 800 SUPERIOR AVENUE, SUITE 1400, CLEVELAND, OH, 44114, US

(73) Assignee: MASTER LOCK COMPANY, Oak Creek, WI (US)

(21) Appl. No.: 10/711,566

(22) Filed: Sep. 24, 2004

Related U.S. Application Data
(60) Provisional application No. 60/481,420, filed on Sep. 25, 2003.

(51) Int. Cl. E05B 73/00

(52) U.S. Cl. 70/30

(57) ABSTRACT

A cable lock that is locked and unlocked through the movement of a set of combination dials. The combination dials are used to provide a proper combination. Upon entry of the proper combination, a knob is used to actuate a lever which releases a locking clamp. A cable is passed through a cable passageway and secured therein when the locking clamp is released. The cable lock may include an unlocked position, a locked position, and a cinch position. Additionally, the lock may include a rest feature to allow the proper combination to be reset.

### CROSS-REFERENCE TO RELATED APPLICATIONS

This application claims the benefit under 35 USC §119(e) of U.S. Provisional Application No. 60/481,420 for CABLE LOCKING MECHANISM filed on Sep. 25, 2003, the entire disclosure of which is hereby incorporated by reference.

### FIELD OF THE INVENTION

The present invention relates to a cable locking mechanism and more specifically to a cable locking mechanism with a resetable combination lock

### BACKGROUND

Locks are necessary to provide security to a variety of items. However, traditional padlocks or other lock constructions are not always applicable to all objects. As such, cables have been used due to their flexibility and adjustable length. Typically, cables are clamped in a manner that crimps the cable, thereby compromising the integrity of the lock. In addition a crimped cable does not readily slide in and out of a lock body, and therefore makes the cable lock difficult to use. Furthermore, cable locks have traditionally been key-operated, which does not afford the conveniences of a keyless lock.

### SUMMARY

The present invention relates to an improved cable lock. The cable lock includes a combination lock that interacts with a locking mechanism to secure a cable passing through a passageway in the cable lock housing. The cable lock can only be operated upon the dialing of the proper combination. In some embodiments, a reset feature is provided that allows for setting a new lock combination.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention. The drawings and detailed description are not intended to and do not limit the scope of the invention or the claims in any way. Instead, the drawings and detailed description only describe embodiments of the invention and other embodiments of the invention not described are encompassed by the claims.

FIG. 1 illustrates an internal view of the locking mechanism of a cable lock of the present invention.

FIG. 2 illustrates an example of a knob that can be used to actuate the locking mechanism.

FIG. 3 is a cross-sectional view of the cable lock.

FIG. 4 illustrates a combination dial and hub subassembly of the cable lock.

FIG. 5 illustrates the combination cable lock of the present invention.

FIG. 6 illustrates an internal view of the locking mechanism of a cable lock of the present invention.

FIG. 7 illustrates the internal components of a cable lock of the present invention.

FIG. 8 illustrates the internal components of a cable lock of the present invention.

FIG. 9 illustrates a cable including a clamp on the free end.

FIG. 10 is a close-up view of the clamp shown in FIG. 9.

FIG. 11 illustrates a cable lock including a protective covering for the combination dials.

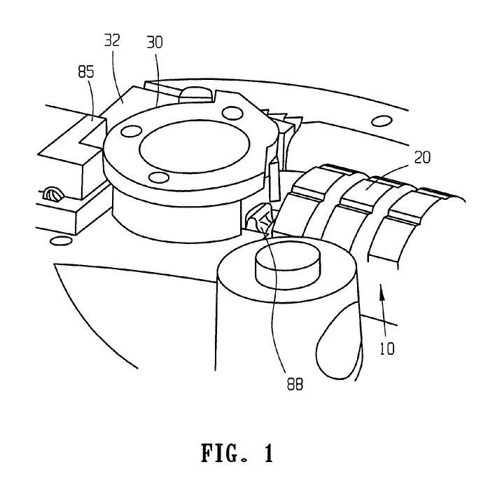

### DETAILED DESCRIPTION

The present invention relates to an improved cable locking mechanism, generally referenced as 10, and an improved cable lock 15. In one embodiment, the cable locking mechanism 10 includes a set of combination dials 20 for locking and unlocking the locking mechanism. The use of the combination dials affords all of the traditional conveniences of a keyless locking mechanism, including not requiring the maintenance of a key and the ability to provide different locking combinations.

The cable locking mechanism 10 generally includes a lever arm 30, one or more locking clamps 32, a locking clamp spring 34, a cable passageway 36, and an actuation means 38, typically a lock cylinder, for engaging and moving the lever arm 30. The cable locking mechanism 10 is generally designed to be used in a cable lock 15, which includes a cable 40 which is flexible or relatively flexible and lock body 42. The cable lock mechanism may also be the same or similar to the locking mechanisms that are described in U.S. Pat. Nos. 6,755,054 and 6,629,440 for CABLE LOCKING MECHANISM, issued Jun. 29, 2004, and ADJUSTABLE CABLE LOCK, issued Oct. 7, 2003, respectively, the entire disclosures of which are hereby incorporated by reference.

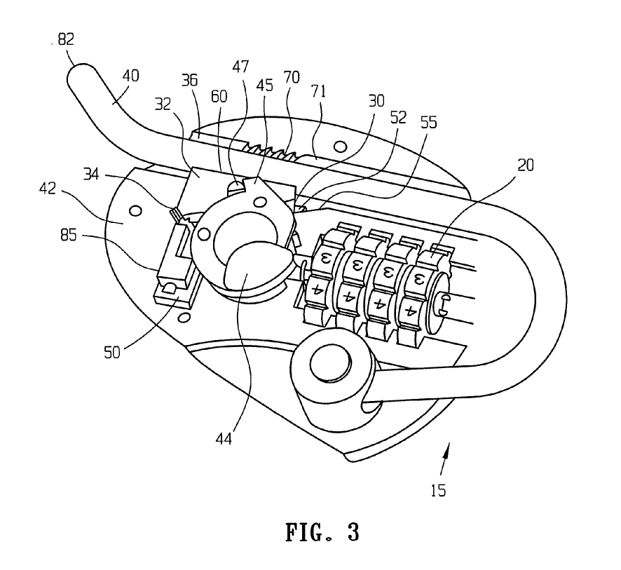

The lever arm 30 can take a variety of shapes and sizes, and in some embodiments, such as those shown in the illustrative figures, may be a rotatable cam. The lever arm 30 is moved or rotated by the actuation means 38 to engage the locking clamp 32 in at least two different positions. In some embodiments, the lever arm 30 engages the locking clamp 32 in three positions, a locked position, an unlocked position, and a cinch position. In some embodiments, as best shown in FIG. 3, the lever arm 30 is generally a cylindrical piece 44 with a protrusion 45 on one edge. Alternatively, the lever arm 30 may be asymmetrical, such that one side of the lever arm acts as a protrusion. Alternatively, the lever arm 30 may have a generally ovular cross-section. Regardless of the chosen geometrical design of the lever arm 30, the principle feature is that the lever arm 30 engages the locking clamp 32 and is capable of disengaging the locking clamp in order to allow the locking clamp to move under spring force. For example, as shown in FIG. 3, if the lever arm 30 is cylindrical with a protrusion 45, as the lever arm 30 is rotated by the actuation means 38, the locking arm 30 rotates from an unlocked position to a locked position. In the unlocked position, the protrusion 45 contacts a portion of the locking clamp 32, shown as a protrusion 47 in FIG. 3, thereby holding the locking clamp 32 against the force of the locking clamp spring 34 such that the locking clamp 32 does not encumber the cable 40 as it is inserted into passageway 36. Once rotated, the protrusion 45 of the locking arm 30 disengages from the protrusion 47 of the locking clamp 32, thereby allowing the locking clamp 32 to move with the spring force and into the passageway 36.

The locking clamp 32 is positioned within a cavity 50 of the cable lock body 42, such as to be generally parallel with the cable passageway 36 which generally runs from one side of the lock body 42 to the other, but not necessarily at 180 degrees through the center axis of the lock body 42. The locking clamp 32 is positioned in locking clamp opening 52 which generally abuts the portion of the cavity which houses the lever arm 30. The locking clamp opening 52 is defined by a surface 55 which slopes outward away from the center axis of the cable passageway 36. The sloped surface 55 is orientated such that the narrower end of the slope is directed closer to the lever arm 30 than the wider end of the sloped surface 55. The locking clamp 32 is generally wedged shaped with a bottom surface 58 which is sloped to match the sloped surface 55. Thus, when the lever arm 30 engages the locking clamp 32 to cause displacement, the locking clamp 32 slides along the sloped surface 55 thereby widening the cable passageway 36 through the locking clamp 32.

Within the locking clamp opening 52 is the locking clamp spring 34 that biases the locking clamp, or locking clamps, 32 toward the lever arm 30. When in the locked or cinched positions, the spring 34 applies sufficient force on the locking clamp 32 to allow the clamp 32 to secure the cable 40 between the clamp 32 and surface 71. The locking clamp spring may be comprised of any known resilient member that can be used to generate a spring force, such as a coil spring, leaf spring, detent spring, rubber tension spring or the like. The movement of the lever arm 30 engages the locking clamp 32 and displaces the locking clamp 32 against the spring force and allows the cable 40 to move freely within the passageway 36.

The top surface 60 of the locking clamp 32 contains a generally hemispherical groove 62 wherein the cable rests. It should be appreciated that the groove 62 need not be hemispherical, but instead can be any configuration that will retain the cable in position. The groove 62 contains a set of toothed protrusions 64 that run perpendicular to the cable 40 length, across the surface of the groove 55. The toothed protrusions 64 assist in with the grasping and retaining the cable 40 as it is inserted through the cable passageway 36. Preferably each protrusion 64 is arranged in an asymmetrical fashion, with one side of the toothed protrusion slightly longer than the other with the protrusion and angled away from the lever arm 30. The angling of the protrusions 64 helps secure the cable 40 in place and prevents the cable 40 from degradation and eventual failure. The other side of the cable 40 is retained within the passageway 36 by a second set of toothed protrusions 70 located on surface 71 of the passageway 36. Thus, when a cable 40 is inserted into the passageway 36 and the locking clamp 32 is released, the cable 40 is retained in the passageway 36 by the toothed protrusions 64 and 70 located on the locking clamp 32 and passageway surface 71, respectively. In an alternative embodiment, a second locking clamp 32 is used in place of the toothed protrusions 70 on the passageway surface 71.

The actuation means 38 may be a lock cylinder or a hasp or a combination lock and knob assembly 80 as discussed further below. The movement of the actuation means 38 is used to move the lever arm 30 to and from the locked and/or cinched position. The actuation means 38 generally includes the locking mechanism, such as a lock cylinder keyway, combination set, or a padlock. The actuation means 38 may take numerous different configurations and designs provided it provides for movement of the lever arm 30 and contains a locking mechanism.

The cable 40 is preferably made of a flexible laminated steel, and is more preferably an impregnated cable. Impregnated cable means that plastic is extruded between the wire strands of the cable. Alternatively, the cable 40 can be covered by a plastic sleeve. Preferably, the cable 40 is a braided cable with seven chords, wherein each chord is made from three strands of seven wires. The cable 40 can vary in length and diameter. The cable 40 comprises a formed end 82, which may be rounded for the purpose of easy insertion into the cable passageway 36. The other end of the cable may either be affixed to the lock body or be loose. If the cable end is affixed to the lock body, it is preferred to attach the cable end to a swivel to allow the cable move be easier to manipulate. In some embodiments, the cable may be replaceable by disengaging the cable from the swivel connection.

The lock body 42 may take on a variety of shapes and sizes. Preferably the lock body 42 is resilient and may include one or more anti-saw plates. In general, the preferred configuration of the lock body 42 is dependent on the desired application of the lock 15.

In order to open cable lock 15 using the locking mechanism 10 described above, the actuation means 38 is manually activated, thereby moving the lever arm 30 into engagement with the locking clamp 32. When the locking clamp 32 is engaged by the lever arm 30, the locking clamp 32 is held or pushed against the force of spring 34 and the cable 40 can freely move in and out of the cable passageway 36. The cable 40 is looped around the object intended to be secured and the formed end 62 is inserted into the cable passageway 36 through cable passageway opening 84.

Upon further movement of the lever arm 30, the protrusion 45 of the lever arm 30 disengages from the locking clamp 32, thereby allowing the spring 34 to act on the locking clamp 32. The spring 34 exerts a force on the locking clamp 32 to slide it up the sloped surface 55 towards the cable 40. As the locking clamp 32 move towards the cable 40, the cable passageway 36 through the locking clamp 32 becomes narrower, until the cable 40 is eventually engaged within the groove 62 in the locking clamp 32. The toothed protrusions 64 and 70 hold the cable 40 in position and prevent the cable 40 from being withdrawn from the lock body 42. A cinch position can thus be obtained prior to locking the lock 15. In the cinch position, the cable 40 can be inserted further into the passageway 36, but may not be withdrawn. Any attempt to withdraw the cable 40 will result in the movement of the locking clamp 32 towards the cable 40 thereby providing a tighter grip on the cable 40.

In order to place the lock 15 in the locked position, the actuation means 38 is again moved in order to move or to rotate the lever arm 30 further. At a certain point, a locking slide 85 which was engaged by the lever arm 30 is released by the lever arm 30 and is spring-biased into engagement with the locking clamp 32. When the locking slide 85 engages the locking clamp 32, the locking clamp 32 cannot be moved down the sloped surface 55 and away from cable 40 and the cable 40 is locked in position.

To disengage the lock 15, the actuation means 38 is moved in an opposite direction as used to engage the lock. The actuation means 38 moves the lever arm 30 into engagement first with the locking slide 85 and then with the locking clamp 32 to move them back against their respective spring forces. The engagement of the locking clamp 32 will displace the locking clamp 32 downward along the sloped surface 55 away from the cable 40, thereby increasing the size of the cable passageway 36 through the locking clamp 32 and moving the locking clamp 32 out of engagement with the cable 40. The cable 40 will thus be permitted to move in either direction, namely into or out of the lock body 42.

It should be appreciated by one skilled in the art that the locking mechanism 10 can take many different forms or configurations and that the interaction of such locking mechanisms with a combination lock and a cable is contemplated by this invention.

In one embodiment, a combination lock and knob assembly 80 is used as the actuation means 38, wherein the combination lock and knob assembly 80 blocks the rotation of a lever arm or cam 30 which is used to move the locking clamp 32, or clamps, into or out of engagement with the cable 40. The rotation of the cam 30 can also actuate a locking slide, 85 that provides a locked position in addition to the cinch position. The shaft 88 of the combination dials 20 blocks the rotation of the cam 30. When the combination dials 20 are turned to the proper combination, the shaft 80 is allowed to move away from the cam 30, which unblocks the cam 30 and allows it to rotate to unlock the lock mechanism 10. The rotation of the cam 30 pushes the shaft 88 towards the lock dials 20. In other embodiments, the movement of the locking slide 85 moves the shaft 88 toward the lock dials. Only when the proper combination is dialed can the shaft 88 move within the lock dials 20 in and out of engagement with the cam 30 or locking slide.

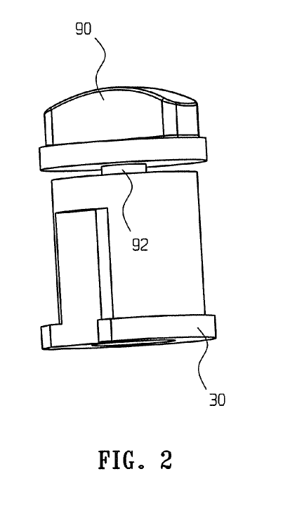

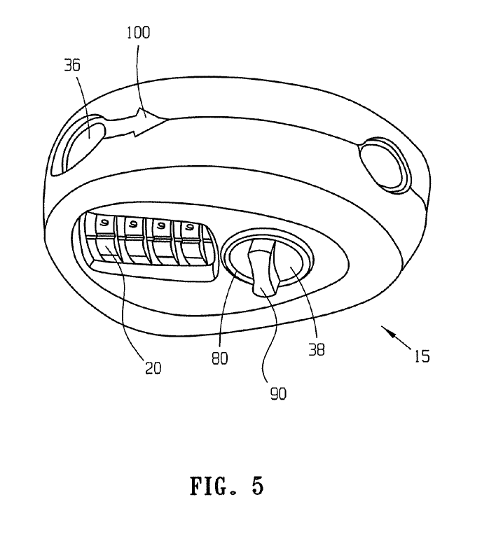

Referring now to FIG. 2, a knob 90, attached to the cam 32, is used to lock and unlock the locking clamp 32 and the locking slide 85. The knob 90 is designed to be actuated by turning in one direction or the other. The knob 90 is connected, either directly or indirectly, to the cam 30 such that rotation of the knob 90 also rotates the cam 30. Indication means 92, as shown in the FIGS. 3 and 5, can be used to indicate which direction the knob should be turned in order to engage or disengage the lock. Indication means 92 can also be used to display the cinched position.

As shown in FIG. 2, the connection 92 between the knob 90 and the cam 30 can be made relatively thin and thus weaker than the cam 30, such the when a large amount of torque is applied to the knob 90 in an attempt to override the locking mechanism, the connection 92 will break, thereby disengaging the knob 90 from the cam 30. This provides an additional security measure for the cable lock is an unauthorized party attempts to break or overpower the lock. The lock 15 may include a tool (not shown), such as a key or other device that will override the lock mechanism should the knob 90 become separated from the cam 30.

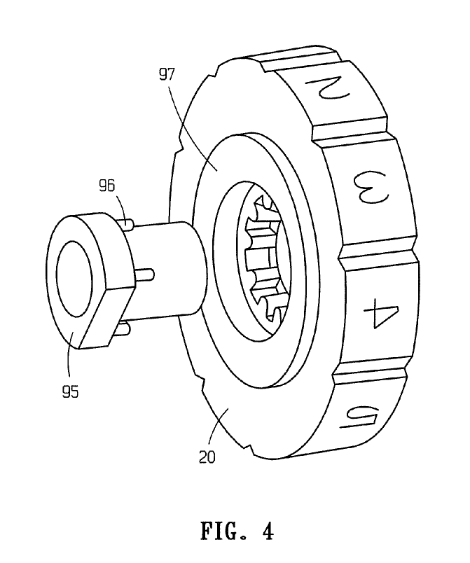

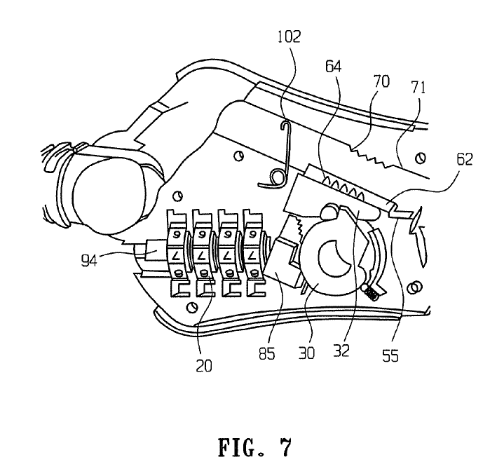

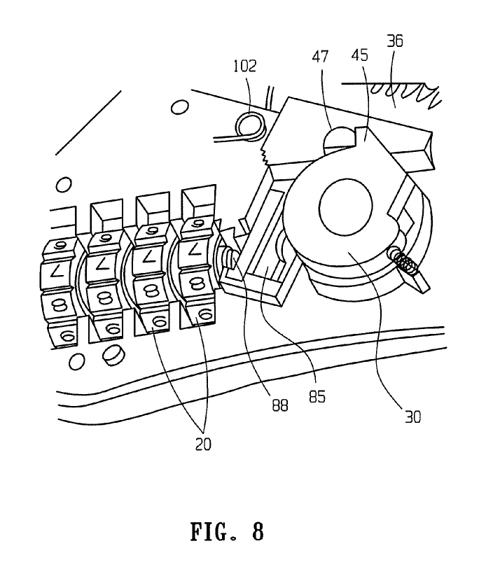

In some embodiments, the cable lock 15 can include a combination reset feature. A reset button 94 such as shown in FIG. 7 is placed in or along the lock body or housing 42, preferably in a location that prevents accidental actuation. The reset button 94 can operate in traditional lock combination reset fashion. For example, when the reset button, or pin, 94 is pressed and the original combination has been set, the hubs 95, which engage the combination dials 20 through a set of interlocking protrusions and splines 96 (see FIG. 4), are moved such that the dials 20 are disengaged and can free spin. A new combination can be set. Releasing the reset button 94 will reengage the hubs 95 with the dials 20 and thereby provide for a new combination. In addition, a shoulder 97 can be added to one or more of the combination dials 20 to prevent a small item from being inserted between the dial 20 and the housing 42 in an attempt to pick the lock or decode the combination.

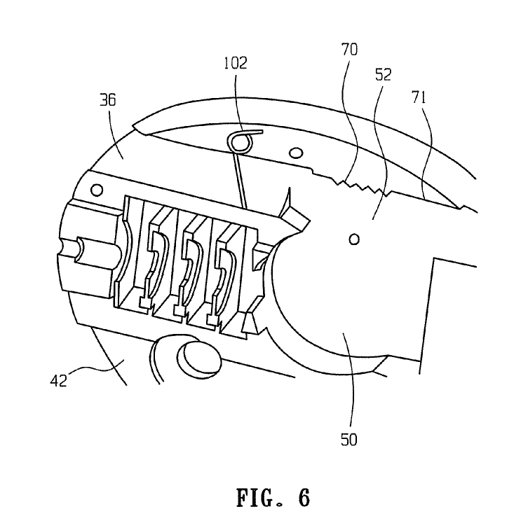

As mentioned above, the operation of the clamp 32 forces the cable 40 to be inserted into the lock in one direction only. Features can be added to avoid the cable 40 from being inserted in the incorrect direction. For example, in one embodiment, an direction indicator 100 (see FIG. 5), such as an arrow, is added to the cable lock body 42, either molded or otherwise applied. In another embodiment, a spring, or other biasing mechanism, 102 (see FIG. 6) is added that allows the cable 40 to pass through the cable passageway 36 in only one direction. If the cable 40 is placed in the passageway 36 in the other direction, the spring 102 blocks the passageway 36.

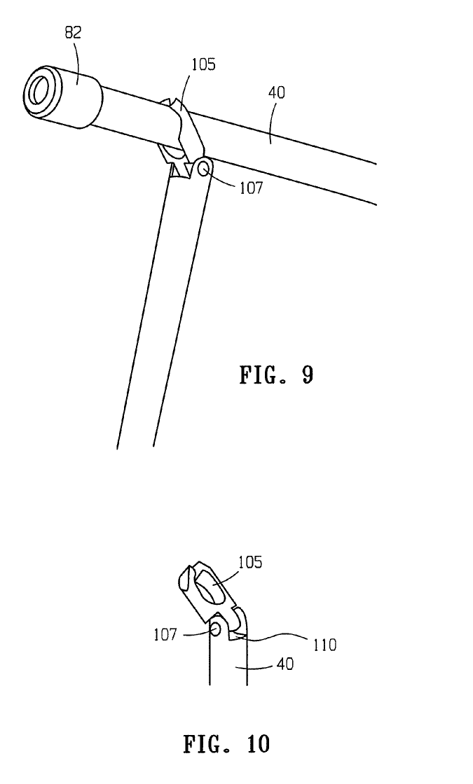

Referring to FIGS. 9 and 10, an additional feature that can be added to the cable lock 15 is a cable clamp 105 that can be affixed to the free end of the cable 40. In one embodiment, the clamp 105 is connected to the cable 40 by a hinge or other pivot point 107. The clamp 105 is sized so that is can easily pass through the cable passageway 36 in the lock body 15. In one embodiment, means, such as a detent 110, are employed to maintain the clamp 105 in alignment with the cable 40 to assist in inserting through the cable passageway 36. Once inserted through the passageway 36, the clamp 105 can be rotated to align with an object to which it can be clamped, such as, for example, a portion of the cable or a portion of the lock housing. As such, when the clamp 105 is utilized, the lock 15 can be stored, applied, or transported in a more compact manner.

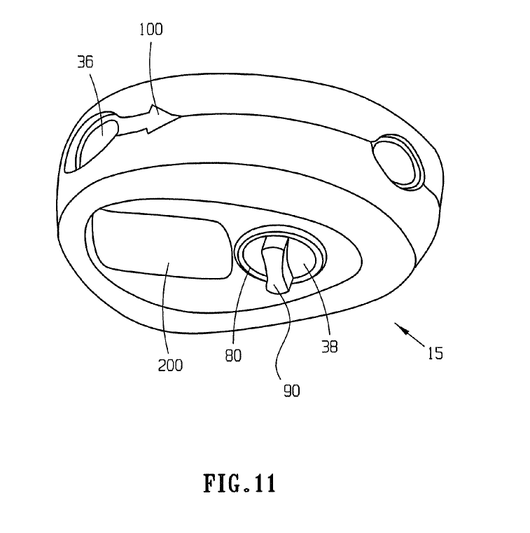

As shown in FIG. 11, another feature that can be added is a cover 200 for the combination dials 20. The cover 200 can take any form and can attach in any number of ways, such as, for example, a snap fit or a friction fit. In addition, the cover 200 can be a separate piece or can be attached to the lock body 42. The cover 200 acts to protect the combination dials 20, and internal lock components, from environmental elements.

The invention has been described with reference to the preferred embodiments. Clearly, modifications and alterations will occur to others upon a reading and understanding of this specification. It is intended to include all such modifications and alterations insofar as they come within the scope of the appended claims or the equivalents thereof.

1. A cable lock comprising:
a flexible cable;
a lock body including a passageway therethrough; and
a combination lock mechanism including a set of combination dials and a lever arm, wherein said lever arm causes a locking member to move into and out of engagement with said flexible cable when said flexible cable is inserted into said passageway.

2. The cable lock of claim 1, wherein said lever arm allows said locking member to move into and out of three positions:
an unlocked position, wherein said cable can be inserted into and removed from said passageway;
a cinch position, wherein said cable can only be inserted into said passageway; and
a locked position, wherein said cable can not be inserted or removed from said passageway.

3. The cable lock of claim 1, wherein said cable includes an end fixably secured to said lock body.

4. The cable lock of claim 1 further comprising a rotatable knob.

5. The cable lock of claim 4, wherein said knob includes a breakable portion that will disengage the knob from the lever arm when sufficient force is applied to said knob.

6. The cable lock of claim 1, wherein said combination lock mechanism includes a reset feature allowing new combinations to be set.

7. The cable lock of claim 6, wherein said reset feature includes a reset button located on a portion of said lock body.

8. The cable lock of claim 1, wherein at least one of said set of combination dials includes a shoulder that prevents access between said at least one of said set of combination dials and said lock body.

9. The cable lock of claim 1, wherein said lock body includes indication features that indicate which direction the cable is to be inserted into the passageway.

10. The cable lock of claim 1 further comprising a spring member located within said passageway that allows said cable to be inserted into said passageway only in one direction.

11. The cable lock of claim 1, wherein said locking member includes a rotatable cam and locking clamp.

12. The cable lock of claim 11, wherein said locking clamp slides along a sloped surface in order to engage and disengage said cable.

13. The cable lock of claim 1 further comprising a pivotable clamp located at one end of said cable.

14. The cable lock of claim 1 further comprising a protective covering that selectively covers said set of combination dials.

15. A cable lock comprising:
(a) a flexible cable;
(b) a lock body including a passageway therethrough; and
(c) lock mechanism, wherein said lock mechanism comprises:
(i) a set of combination dials having an unlocking combination;
(ii) a rotatable cam;
(iii) a knob; and
(iv) a shaft selectively engageable with said cam;
wherein said cam rotates to provide an unlocked position only when said set of combination dials are manipulated to said unlocking combination.

16. The cable lock of claim 15 wherein cam rotates to engage and disengage a locking clamp, wherein said locking clamp engages said cable in said passageway when said cam disengages said locking clamp.

17. The cable lock of claim 15, wherein said cable lock includes three positions:
an unlocked position, wherein said cable can be inserted into and removed from said passageway;
a cinch position, wherein said cable can only be inserted into said passageway; and
a locked position, wherein said cable can not be inserted or removed from said passageway.

18. The cable lock of claim 15, wherein said cable includes an end fixably secured to said lock body.

19. The cable lock of claim 15 further including a reset feature allowing new combinations to be set.

20. The cable lock of claim 19, wherein said reset feature includes a reset button located on a portion of said lock body.

21. The cable lock of claim 15, wherein at least one of said set of combination dials includes shoulder that prevents access between said at least one of said set of combination dials and said lock body.

22. The cable lock of claim 15, wherein said lock body includes indication features that indicate which direction the cable is to be inserted into the passageway.

23. The cable lock of claim 15 further comprising a spring member located within said passageway that allows said cable to be inserted into said passageway only in one direction.

24. The cable lock of claim 15 further comprising a pivotable clamp located at one end of said cable.

25. The cable lock of claim 24, wherein said pivotable clamp include a detent mechanism that secures said pivotable clamp in a predefined orientation.

26. The cable lock of claim 15 further comprising a protective covering that selectively covers said set of combination dials.

27. A cable lock comprising:
(a) a flexible cable;
(b) a lock body including a passageway therethrough; and
(c) lock mechanism, wherein said lock mechanism comprises:
(i) a set of combination dials;
(ii) a rotatable cam;
(iii) a knob; and
(iv) a connecting member connecting said cam with said knob;
wherein said connecting member is breakable such that said knob will disconnect from said cam when sufficient force is applied to said knob.

28. A cable lock comprising:
(a) a flexible cable;
(b) a lock body including a passageway therethrough; and
(c) a lock mechanism comprising:
(i) a set of combination dials connected to a corresponding set of hubs;
(ii) a rotatable cam;
(iii) a knob connected to said cam; and
(iv) a reset button that disengages said set of combination dials from said corresponding set of hubs, thereby allowing a combination to be set.

29. The cable lock of claim 28 further comprising a pivotable clamp located at one end of said cable.

30. The cable lock of claim 29, wherein said pivotable clamp include a detent mechanism that secures said pivotable clamp in a predefined orientation.

31. The cable lock of claim 28, wherein said cable lock includes three positions:
an unlocked position, wherein said cable can be inserted into and removed from said passageway;
a cinch position, wherein said cable can only be inserted into said passageway; and
a locked position, wherein said cable can not be inserted or removed from said passageway.

32. A cable lock comprising:
(a) a flexible cable;
(b) a lock body including a passageway therethrough;
(c) a lock mechanism comprising:
(i) a set of combination dials connected to a corresponding set of hubs; and
(ii) a knob for actuating said knob; and
(d) a pivotable clamp located at one end of said cable.

33. The cable lock of claim 32, wherein said pivotable clamp include a detent mechanism that secures said pivotable clamp in a predefined orientation

34. A cable lock comprising:
a flexible cable;
a lock body including a passageway therethrough; and
a combination lock mechanism including a set of combination dials and a means for moving a locking member into and out of engagement with said flexible cable when said flexible cable is inserted into said passageway.
